(19) United States
(12) Patent Application Publication
(10) Pub. No.: US 2010/0273001 A1
(43) Pub. Date: Oct. 28, 2010

(54) Method of Recycling Carpet Components and Carpet Components formed Therefrom

(76) Inventor: Joseph Z. Keating, Lilburn, GA (US)

Correspondence Address: WITHERS & KEYS, LLC, P. O. BOX 2049, MCDONOUGH, GA, 30253, US

(21) Appl. No.: 12/789,631

(22) Filed: May 28, 2010

Related U.S. Application Data
(63) Continuation-in-part of application No. 12/427,782, filed on Apr. 22, 2009.

(51) Int. Cl. B32B 5/16; B02C 19/00; B02C 23/00

(52) U.S. Cl. 428/407; 241/14; 241/22

(57) ABSTRACT

Methods of recycling carpet components are disclosed. Usable compositions containing recycled carpet components, and carpets and carpet components containing recycled carpet components are also disclosed.

### CROSS-REFERENCE TO RELATED APPLICATIONS

This patent application claims the benefit of priority to and is a continuation-in-part of U.S. patent application Ser. No. 12/427,782 filed on Apr. 22, 2009, the subject matter of both of which is hereby incorporated by reference in its entirety.

### TECHNICAL FIELD

The present invention relates to methods of recycling carpet components, usable compositions containing recycled carpet components, and new carpets and carpet components containing recycled carpet components.

### BACKGROUND

Efforts continue to further develop ways to effectively and efficiently recycle carpet components.

### SUMMARY

The present invention continues the effort to further develop ways to effectively and efficiently recycle carpet components by the discovery of methods of recycling carpet components previously destined for landfills. The methods of the present invention enable the formation of a free-flowing powder from a tacky first mixture of used carpet components. The resulting free-flowing powder has substantially no tackiness and is suitable for incorporation into new carpet components such as a new carpet backing or a new carpet adhesive component.

Accordingly, the present invention is directed to methods of recycling carpet components. In one exemplary embodiment, the method of recycling carpet components comprises separating at least a portion of fibers from a first mixture of carpet components comprising carpet fibers, a carpet adhesive component, and used filler material so as to form a second mixture comprising residual carpet fibers, the carpet adhesive component, and the used filler material; and co-grinding the second mixture with a solid inorganic particulate material that may be at least partially encapsulated within and/or coated with a polymeric or resinous material, wherein said co-grinding step results in a third mixture comprising a free-flowing powder having an average particle size. Typically, the free-flowing powder has an average particle size of less than 50 microns (μm), and a particle size range of from about 1.0 μm to about 300 μm.

The present invention is further directed to the free-flowing powder resulting from the disclosed methods of recycling carpet components. In one exemplary embodiment, the free-flowing powder comprises (i) particles of recycled carpet material, the recycled carpet material comprising residual carpet fibers or carpet fiber portions, a carpet adhesive component, and used filler material; and (ii) solid inorganic particulate material, the solid inorganic particulate material being from a source other than recycled carpet material, wherein the free-flowing powder has a particle size ranging from about 1.0 to about 300 microns (μm). Typically, the free-flowing powder has an average particle size of less than 50 μm.

In another exemplary embodiment, the free-flowing powder comprises (i) particles of recycled carpet material, the recycled carpet material comprising residual carpet fibers or carpet fiber portions, a carpet adhesive component, and used filler material; (ii) solid inorganic particulate material, the solid inorganic particulate material being from a source other than recycled carpet material, wherein the free-flowing powder has a particle size ranging from about 1.0 to about 300 microns (μm); and (iii) a polymeric or resinous material separated from the solid inorganic particulate material or at least partially encapsulating and/or coating the solid inorganic particulate material, wherein the free-flowing powder has a particle size ranging from about 1.0 to about 300 microns (μm). Typically, the free-flowing powder has an average particle size of less than 50 μm.

The present invention is even further directed to carpet components comprising the free-flowing powder resulting from the disclosed methods of recycling carpet components. In one exemplary embodiment, the carpet component comprises free-flowing powder, wherein the free-flowing powder comprises (i) particles of recycled carpet material, the recycled carpet material comprising residual carpet fibers or carpet fiber portions, a carpet adhesive component, and used filler material; (ii) solid inorganic particulate material, the solid inorganic particulate material being from a source other than recycled carpet material; and (iii) a polymeric or resinous material separated from the solid inorganic particulate material or at least partially encapsulating or coating the solid inorganic particulate material, wherein the free-flowing powder has a particle size ranging from about 1.0 to about 300 microns (μm). The carpet component may further comprise one or more additional components such as a polymeric matrix material, a latex component, carpet fibers, or any combination thereof.

These and other features and advantages of the present invention will become apparent after a review of the following detailed description of the disclosed embodiments and the appended claims.

### BRIEF DESCRIPTION OF THE FIGURE

The present invention is further described with reference to the appended figure, wherein:

FIG. 1 depicts a flow diagram of an exemplary method of recycling carpet components according to the present invention.

### DETAILED DESCRIPTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

The present invention is directed to methods of recycling carpet components. The present invention is further directed to the free-flowing powder resulting from the disclosed methods of recycling carpet components. The present invention is even further directed to carpet components comprising the free-flowing powder resulting from the disclosed methods of recycling carpet components.

In one exemplary embodiment, the method of recycling carpet components comprises separating at least a portion of fibers from a first mixture of carpet components comprising carpet fibers, a carpet adhesive component, and used filler material so as to form a second mixture comprising residual carpet fibers, the carpet adhesive component, and the used filler material; and co-grinding the second mixture with a solid inorganic particulate material that may be at least partially encapsulated within or coated with a polymeric or resinous material, wherein the co-grinding step results in a third mixture comprising a free-flowing powder having an average particle size. An exemplary first mixture of carpet components comprises from about 40 to about 60 wt % of the carpet fibers; from about 5.0 to about 20 wt % of the adhesive component; and from about 15 to about 40 wt % of the used filler material; wherein all weight percentages are based on a total weight of the first mixture.

Prior to processing, the first mixture comprises a tacky, conglomerating mixture that alone is incapable of being ground into a free-flowing powder due to the tackiness of the carpet adhesive component (e.g., a latex binder) within the first mixture. The method of the present invention enables the tacky first mixture to be converted into a free-flowing powder by separating at least a portion of fibers from the first mixture, and co-grinding solid inorganic particulate material with the tacky second mixture (i.e., the first mixture minus a portion of carpet fibers within the first mixture). The co-grinding step results in a free-flowing powder, wherein at least a portion of the free-flowing powder comprises particles comprising (i) a portion of the carpet adhesive component at least partially surrounded by at least one of (ii) a portion of the solid inorganic particulate material, and (iii) a polymeric or resinous material that at least partially encapsulated or coated the co-ground solid inorganic particulate material prior to the co-grinding step.

The separating step may comprise any separation step that removes at least a portion of carpet fibers from the tacky first mixture. Suitable separation steps include, but are not limited to, one or more screening steps, one or more gravity separation steps, one or more air classification steps, or any combination thereof. In some desired embodiments, the separation step comprises processing the first mixture through one or more screening steps utilizing, for example, one or more screens having a screen mesh size ranging from about 10 to about 80 mesh (e.g., a sieve opening size of from about 0.18 to about 2.0 millimeters (mm)).

In the co-grinding step, an effective amount of solid inorganic particulate material that may be at least partially encapsulated within and/or coated with a polymeric or resinous material is co-ground with the second mixture in order to form a free-flowing powder. The co-grinding step may comprise processing the second mixture through one or more grinding mills such as one or more hammer mills, one or more ball mills, one or more roller mills, or any combination thereof.

Typically, solid inorganic particulate material that may be at least partially encapsulated within and/or coated with a polymeric or resinous material is added to the second mixture so as to form a third mixture, wherein the third mixture comprises from about 10 to about 90 weight percent (wt %) of the second mixture, and from about 90 to about 10 weight percent (wt %) of the solid inorganic particulate material that may be at least partially encapsulated within and/or coated with a polymeric or resinous material. In more desired embodiments, solid inorganic particulate material that may be at least partially encapsulated within and/or coated with a polymeric or resinous material is added to the second mixture so as to form a third mixture, wherein the third mixture comprises from about 20 to about 80 weight percent (wt %) of the second mixture, and from about 80 to about 20 weight percent (wt %) of the solid inorganic particulate material that may be at least partially encapsulated within and/or coated with a polymeric or resinous material.

Suitable solid inorganic particulate material for use in the present invention includes, but is not limited to, (i) new filler material selected from calcium carbonate, limestone, alumina trihydrate, brucite (i.e., magnesium hydroxide), feldspar, dolomite, silica, clay, granite, barium sulfate, hematite or other iron minerals, any other mineral that can be processed into a powder, or any combination thereof (ii) post industrial filler material selected from calcium carbonate, limestone, alumina trihydrate, brucite (i.e., magnesium hydroxide), feldspar, dolomite, silica, clay, granite, barium sulfate, hematite or other iron minerals, any other mineral that can be processed into a powder, fly ash, glass (e.g., e-glass), and any combination thereof (iii) post consumer filler material comprising post consumer glass, recycled paper, calcium carbonate, limestone, alumina trihydrate, brucite (i.e., magnesium hydroxide), feldspar, dolomite, silica, clay, granite, barium sulfate, hematite or other iron minerals, any other mineral that can be processed into a powder, and any combination thereof; or (iv) any combination of any of (i), (ii) and (iii). In some exemplary embodiments, the solid inorganic particulate material comprises calcium carbonate and/or limestone. In some exemplary embodiments, the solid inorganic particulate material comprises post consumer glass (e.g., ground glass) from post consumer glass sources such as beverage containers, vehicle windshields, fluorescent lights, other post consumer glass containers (e.g., jars), or any combination thereof.

In other exemplary embodiments, the solid inorganic particulate material for use in the co-grinding step of the present invention comprises solid inorganic particulate material that is at least partially encapsulated within and/or coated with a polymeric or resinous material. As used herein, “at least partially encapsulated within a polymeric or resinous material” describes solid inorganic particulate material, such as any one or any combination of the above-described solid inorganic particulate materials, partially embedded (i.e., a portion of one or more particles is exposed) or completely embedded (i.e., the particles are not exposed) within a polymeric or resinous material.

Solid inorganic particulate material that is at least partially encapsulated within and/or coated with a polymeric or resinous material includes, but is not limited to, any solid inorganic particulate material or combination of solid inorganic particulate materials, such as any of the above-described solid inorganic particulate materials, in combination with a polymeric or resinous material. Typically, the polymeric or resinous material is in a hardened state (e.g., a solid thermoplastic material, and a thermoset material) with little, if any, tackiness (e.g., a PVC tile); however, in some embodiments, the polymeric or resinous material may be a flowable material with or without a degree of tackiness (e.g., asphalt).

Typically, the solid inorganic particulate material that is at least partially encapsulated within and/or coated with a polymeric or resinous material comprises post-consumer material. More typically, the solid inorganic particulate material that is at least partially encapsulated within and/or coated with a polymeric or resinous material comprises post-consumer material that does not originate within the carpet industry. Two examples of particularly useful solid inorganic particulate material that is at least partially encapsulated within and/or coated with a polymeric or resinous material for use in the present invention comprise polyvinyl chloride (PVC) tiles and asphalt based pavement. Recyclable PVC tile typically comprises about 87 wt % limestone and about 13 wt % PVC resin. Recyclable asphalt-based pavement typically comprises a mixture of about 95 wt % mixed solid inorganic particulate materials of limestone, dolomite, silica, and feldspar, and about 5 wt % asphalt tar.

With regard to recyclable PVC tile and similar recyclable materials used as the co-ground solid inorganic particulate material, given the relatively small size of the solid inorganic particulate material (e.g., the limestone typically having a particle size of less than 300 μm) embedded within the hardened polymeric resin (e.g., the PVC resin) of the recyclable tile (and similar recyclable materials), free-flowing powder resulting from co-grinding of the recyclable PVC tile (or similar recyclable materials) typically comprises particles comprising (i) a portion of the carpet adhesive component at least partially surrounded by (ii) a portion of the co-ground solid inorganic particulate still embedded within the hardened polymeric resin (e.g., the PVC resin).

With regard to recyclable asphalt and similar recyclable materials, given the relatively large size of the solid inorganic particulate material (e.g., the aggregate may have particle sizes of up to 0.5 inch or greater) embedded within the hardened resin (e.g., the asphalt resin) of the recyclable asphalt, free-flowing powder resulting from co-grinding of the recyclable asphalt (or similar recyclable materials) typically comprises particles comprising (i) a portion of the carpet adhesive component at least partially surrounded by (ii) a portion of the solid inorganic particulate previously embedded within the hardened resin (e.g., the asphalt resin) with possible additional solid inorganic particulate previously embedded within the hardened resin (e.g., the asphalt resin) dispersed throughout the free-flowing powder.

As discussed above, the solid inorganic particulate materials may be either used alone or mixed in some combination, and may be derived from natural sources, and/or sources recycled from mixtures of solid inorganic particulate material with one or more organic compounds/polymers/resins. Typically, the organic content of the solid inorganic particulate material that is at least partially encapsulated within and/or coated with a polymeric or resinous material comprises less than about 20 wt % polymeric or resinous material; however, the organic content of the solid inorganic particulate material that is at least partially encapsulated within and/or coated with a polymeric or resinous material may be much higher (e.g., from about 5 to about 95 wt % solid inorganic particulate material and from about 95 to about 5 wt % polymeric or resinous material).

Polymeric or resinous materials at least partially encapsulating and/or coating the solid inorganic particulate materials may include any post-consumer polymeric or resinous material. Exemplary polymeric or resinous materials include, but are not limited to, PVC resins, asphaltic tars, bitumen, other hydrocarbons, tar, polyolefin resins, thermoplastic polymers and resins, and thermoset polymers and resins.

In place of or in addition to the co-grinding step, any one or combination of the above-mentioned solid inorganic particulate materials (i.e., solid inorganic particulate material alone and/or solid inorganic particulate material that is at least partially encapsulated within and/or coated with a polymeric or resinous material) may be added to the second mixture so as to form the third mixture. For example, any one or combination of the above-mentioned solid inorganic particulate materials (i.e., solid inorganic particulate material alone and/or solid inorganic particulate material that is at least partially encapsulated within and/or coated with a polymeric or resinous material) may be simply added to and blended with the second mixture to form the third mixture. In other embodiments, any one or combination of the above-mentioned solid inorganic particulate materials (i.e., solid inorganic particulate materials alone and/or solid inorganic particulate material that is at least partially encapsulated within and/or coated with a polymeric or resinous material) may be added to and co-grinded with the second mixture to form the third mixture. In other embodiments, a first portion of any one or combination of the above-mentioned solid inorganic particulate materials (i.e., solid inorganic particulate material alone and/or solid inorganic particulate material that is at least partially encapsulated within and/or coated with a polymeric or resinous material) may be added to and co-grinded with the second mixture, and a second portion of any one or combination of the above-mentioned solid inorganic particulate materials (i.e., solid inorganic particulate material alone and/or solid inorganic particulate material that is at least partially encapsulated within and/or coated with a polymeric or resinous material) may be added to and blended with the resulting co-ground composition to form the third mixture.

The resulting free-flowing powder typically has an average particle size that ranges from about 1.0 to about 50 microns (μm) (or from about 1.0 to about 40 μm, or from about 1.0 to about 30 μm). Further, the resulting free-flowing powder typically has a particle size ranging from about 1.0 to about 300 microns (μm) (or from about 1.0 to about 250 μm, or from about 1.0 to about 200 μm, or from about 1.0 to about 150 μm, or from about 1.0 to about 100 μm, or from about 1.0 to about 50 μm).

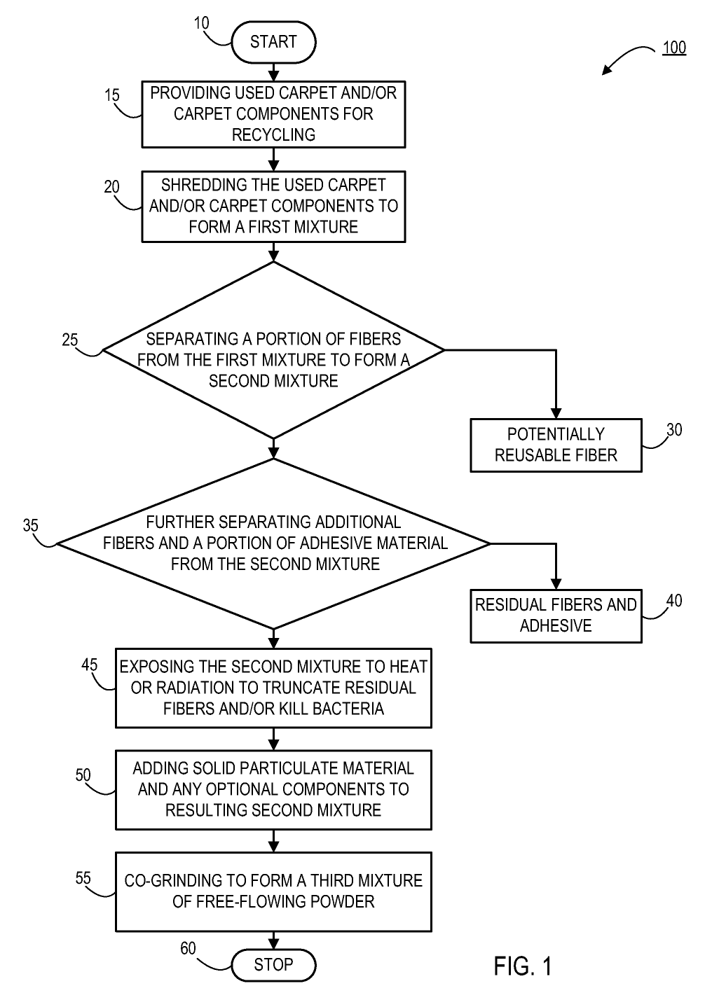

An exemplary method of recycling carpet components according to the present invention is depicted in FIG. 1. As shown in FIG. 1, exemplary method of recycling 100 comprises start 10 followed by step 15, wherein used carpet and/or carpet components are provided for recycling. From step 15, exemplary method 100 proceeds to step 20, wherein used carpet and/or carpet components are shredded to form a first mixture. From step 20, exemplary method 100 proceeds to first separation step 25, wherein a portion of carpet fibers are separated from and removed from the first mixture to form a second mixture.

The removed carpet fibers are shown in box 30 of exemplary method 100. It should be noted that the removed carpet fibers are potentially reusable fibers for carpet applications or other possible uses. Typically, from about 40 to about 60 wt % of the first mixture is recovered as potentially reusable fibers, while about 60 to about 40 wt % of the first mixture remains as the second mixture.

As shown in FIG. 1, from step 20, exemplary method 100 proceeds to second separation step 35, wherein additional residual fibers and a portion of the adhesive material is separated from and removed from the second mixture. The removed additional residual fibers and portion of the adhesive material are shown in box 40 of exemplary method 100. Typically, from about 1.0 to about 30 wt % of the second mixture is removed during step 35 in the form of additional residual fibers and a portion of adhesive material, for example, any adhesive material having a particle size greater than about 4.7 millimeters (mm) (i.e., using a 4 mesh screen). The remaining 99 to 70 wt % of the second mixture proceeds to step 45 of exemplary method 100.

It should be noted that second separation step 35 is not necessary in all embodiments of the present invention. In other words, second separation step 35 is an optional step in some of the methods of the present invention.

In step 45, the second mixture is exposed to heat and/or radiation to truncate the residual fibers and/or kill any bacteria/fungi (collectively referred to as “microorganisms”) present in the second mixture. Typically, when exposed, the second mixture is exposed to a temperature of from about 100 to about 250° C. or UV light for a time period ranging from about 20 to about 200 seconds.

It should be noted that exposure step 45 is not necessary in all embodiments of the present invention. In other words, exposure step 45 is an optional step in some of the methods of the present invention.

As shown in FIG. 1, from optional exposure step 45, exemplary method 100 proceeds to step 50, wherein solid particulate material (i.e., solid inorganic particulate material alone and/or solid inorganic particulate material that is at least partially encapsulated within and/or coated with a polymeric or resinous material) is added to the second mixture. Any of the above-mentioned solid particulate materials (i.e., solid inorganic particulate material alone and/or solid inorganic particulate material that is at least partially encapsulated within and/or coated with a polymeric or resinous material) may be added to the second mixture at this time. It should be noted that other optional components may also be added to the second mixture during this step (or during a subsequent addition step (not shown)). Other optional components that may also be added to the second mixture include, but are not limited to, a biocide, organic flow agents (e.g., propylene or ethylene glycol or triethanolamine), or any combination thereof.

From step 55, exemplary method 100 proceeds to step 55, wherein the second mixture, solid particulate material (i.e., solid inorganic particulate material alone and/or solid inorganic particulate material that is at least partially encapsulated within and/or coated with a polymeric or resinous material), and any other optional components are co-ground with one another to produce a third mixture comprising a free-flowing powder having a desired particle size. As noted above, typically, the resulting free-flowing powder has an average particle size of less than 50 μm. In some embodiments, the resulting free-flowing powder has an average particle size ranging from about 15 to about 40 μm. In other embodiments, the resulting free-flowing powder has an average particle size ranging from about 5 to about 30 μm.

In some embodiments, the resulting free-flowing powder contains greater than 10 wt % of post consumer content (e.g., post consumer glass, recycled paper, etc.). Desirably, the resulting free-flowing powder contains from about 10 to about 90 wt % of post consumer content.

It should be understood that steps 50 and 55 may occur substantially simultaneously. In other words, the second mixture, solid particulate material (i.e., solid inorganic particulate material alone and/or solid inorganic particulate material that is at least partially encapsulated within and/or coated with a polymeric or resinous material) and any other optional components may be simultaneously added, from one or more sources, directly into a co-grinding apparatus as oppose to mixing/blending prior to advancing to the co-grinding apparatus.

As shown in FIG. 1, from step 55, exemplary method 100 proceeds to stop box 60. Although not shown in FIG. 1, exemplary methods of recycling carpet and/or carpet components, such as exemplary method 100, may further comprise additional process steps as discussed herein. For example, in some embodiments, the above-described exemplary method (i.e., exemplary method of recycling 100) may further comprise a pre-heating step before step 15 (i.e., the providing step) or between step 15 and step 20 (i.e., the shredding step). In this optional pre-processing step, recycled carpet or a recycled carpet component (e.g., recycled carpet backing) is heated to a temperature of between about 400 to about 500° C. in a reduced oxygen atmosphere so as to remove organics from the recycled carpet or a recycled carpet component. The organics may be routed to a downstream combustion chamber. The resultant “organic-free” recycled carpet or a recycled carpet component may be further processed as described in FIG. 1.

In this exemplary pre-processing step, the temperature of the heating chamber is typically closely regulated to prevent decomposition of any filler material (e.g., limestone and/or dolomitic filler) present in the recycled carpet or a recycled carpet component. For example, if limestone or dolomitic filler decomposes into CaO or MgO and CO₂, the resulting filler material is no longer usable in a subsequent latex. Decomposition of limestone and dolomite occurs between about 500 and 600° C. Consequently, in some embodiments, a pre-heating temperature of from between 400 and 500° C. is desirable for pre-conditioning the recycled carpet or a recycled carpet component prior to shedding. If the heating chamber is not oxygen deficient, the organic content in the heating chamber can possibly ignite, raising the temperature in the heating chamber to a point higher than the decomposition temperature of the limestone and/or dolomite.

The methods of recycling carpet components in accordance with the present invention may further comprise incorporating the free-flowing powder into a new carpet component. For example, the free-flowing powder may be incorporated into a new carpet backing, a new carpet adhesive component, a polyethylene, a polyvinyl chloride, a plastisol, a urethane, a SBR (i.e., styrene-butadiene rubber) latex, a vinyl acetate latex, or any combination thereof. Further, the methods of recycling carpet components in accordance with the present invention may further comprise one or more additional method steps including, but not limited to, offering for sale the free-flowing powder, and offering for sale a new carpet component comprising the free-flowing powder.

The present invention is further directed to the free-flowing powder resulting from the disclosed methods of recycling carpet components. Typically, the free-flowing powder comprises (i) particles of recycled carpet material, the recycled carpet material comprising residual carpet fibers or carpet fiber portions, a carpet adhesive component, and used filler material; and (ii) solid inorganic particulate material (i.e., solid inorganic particulate material alone and/or solid inorganic particulate material that is at least partially encapsulated within and/or coated with a polymeric or resinous material), the solid inorganic particulate material being from a source other than recycled carpet material; wherein the free-flowing powder has an average particle size ranging from about 1.0 to about 50 microns (μm) (or from about 1.0 to about 40 μm, or from about 1.0 to about 30 μm), and a particle size ranging from about 1.0 to about 300 microns (μm) (or from about 1.0 to about 250 μm, or from about 1.0 to about 200 μm, or from about 1.0 to about 150 μm, or from about 1.0 to about 100 μm, or from about 1.0 to about 50 μm). As discussed above, typically, at least a portion of the free-flowing powder comprises particles comprising (i) a portion of the carpet adhesive component at least partially surrounded by (ii) a portion of the solid inorganic particulate material (i.e., solid inorganic particulate material alone and/or solid inorganic particulate material that is at least partially encapsulated within and/or coated with a polymeric or resinous material and/or polymeric or resinous material separated from but previously encapsulating and/or coating the solid inorganic particulate material).

Further, as discussed above, the free-flowing powder resulting from the disclosed methods of recycling carpet components comprises from about 10 to about 90 weight percent (wt %) of the second mixture (i.e., recycled carpet components), and from about 90 to about 10 weight percent (wt %) of the solid inorganic particulate material (i.e., (1) solid inorganic particulate material alone and/or (2) solid inorganic particulate material that is at least partially encapsulated within and/or coated with a polymeric or resinous material and/or (3) polymeric or resinous material separated from but previously encapsulating and/or coating the solid inorganic particulate material) (e.g., post consumer filler material). In more desired embodiments, the free-flowing powder resulting from the disclosed methods of recycling carpet components comprises from about 20 to about 80 wt % of the second mixture (i.e., recycled carpet components), and from about 80 to about 20 wt % of the solid inorganic particulate material (i.e., (1) solid inorganic particulate material alone and/or (2) solid inorganic particulate material that is at least partially encapsulated within and/or coated with a polymeric or resinous material and/or (3) polymeric or resinous material separated from but previously encapsulating and/or coating the solid inorganic particulate material) (e.g., post consumer filler material).

The present invention is even further directed to new carpet components comprising the free-flowing powder resulting from the disclosed methods of recycling carpet components. In one exemplary embodiment, the new carpet component comprises free-flowing powder, wherein the free-flowing powder comprises (i) particles of recycled carpet material, the recycled carpet material comprising residual carpet fibers or carpet fiber portions, a carpet adhesive component, and used filler material; (ii) solid inorganic particulate material (i.e., (1) solid inorganic particulate material alone and/or (2) solid inorganic particulate material that is at least partially encapsulated within and/or coated with a polymeric or resinous material and/or (3) polymeric or resinous material separated from but previously encapsulating and/or coating the solid inorganic particulate material), the solid inorganic particulate material being from a source other than recycled carpet material. As discussed above, the free-flowing powder within the new carpet component has an average particle size ranging from about 1.0 to about 50 microns (μm) (or from about 1.0 to about 40 μm, or from about 1.0 to about 30 μm), and a particle size ranging from about 1.0 to about 300 microns (μm) (or from about 1.0 to about 250 μm, or from about 1.0 to about 200 μm, or from about 1.0 to about 150 μm, or from about 1.0 to about 100 μm, or from about 1.0 to about 50 μm).

The new carpet component desirably comprises at least about 10 wt % of post consumer filler material, such as the exemplary post consumer filler material described above. In some embodiments, the new carpet component comprises at least about 12 wt % (or at least about 14 wt %, or at least about 16 wt %, or at least about 18 wt %, or at least about 20 wt %, or greater than about 20 wt %) of post consumer filler material, such as the exemplary post consumer filler material described above, in combination with the second mixture as described above. Suitable new carpet components include, but are not limited to, a new carpet backing, a new carpet adhesive component, and/or any other material used to form a new carpet component.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

What is claimed is:

1. A method of recycling carpet components, said method comprising:
separating at least a portion of fibers from a first mixture of carpet components comprising carpet fibers, a carpet adhesive component, and used filler material so as to form a second mixture comprising residual carpet fibers, the carpet adhesive component, and the used filler material; and
co-grinding the second mixture with a solid inorganic particulate material that is at least partially encapsulated within or coated with a polymeric or resinous material, wherein said co-grinding step results in a third mixture comprising a free-flowing powder having an average particle size.

2. The method of claim 1, wherein at least a portion of the free-flowing powder comprises particles comprising (i) a portion of the carpet adhesive component at least partially surrounded by at least one of (ii) a portion of the solid inorganic particulate material, and (iii) a polymeric or resinous material that at least partially encapsulated or coated the solid inorganic particulate material prior to the co-grinding step.

3. The method of claim 1, wherein the average particle size of the third mixture ranges from about 1.0 to about 50 microns (μm).

4. The method of claim 1, wherein the third mixture comprises particles having a particle size ranging from about 1.0 to about 300 microns (μm).

5. The method of claim 1, wherein the third mixture comprises from about 10 to about 90 weight percent (wt %) of the second mixture, and from about 90 to about 10 weight percent (wt %) of the solid inorganic particulate material that is at least partially encapsulated within or coated with a polymeric or resinous material.

6. The method of claim 1, wherein the third mixture comprises from about 20 to about 80 weight percent (wt %) of the second mixture, and from about 80 to about 20 weight percent (wt %) of the solid inorganic particulate material that is at least partially encapsulated within or coated with a polymeric or resinous material.

7. The method of claim 1, wherein the solid inorganic particulate material that is at least partially encapsulated within or coated with a polymeric or resinous material comprises (i) recycled tile; (ii) recycled asphalt; or (iii) any combination of any of (i) and (ii).

8. The method of claim 7, wherein the solid inorganic particulate material that is at least partially encapsulated within or coated with a polymeric or resinous material comprises recycled asphalt.

9. The method of claim 1, further comprising a pre-heating step, wherein at least one recycled carpet component is heated to a temperature to remove organic material from the at least one recycled carpet component without negatively impacting any used filler material therein.

10. The method of claim 9, wherein the temperature ranges from about 400 to about 500° C.

11. The method of claim 1, wherein said separating step comprises processing the first mixture through one or more screens having a screen mesh size ranging from about 10 to about 80 mesh; and said co-grinding step comprises processing the second mixture and the solid inorganic particulate material through one or more grinding mills.

12. The method of claim 1, wherein the first mixture comprises:
from about 40 to about 60 wt % of the carpet fibers;
from about 5 to about 20 wt % of the adhesive component; and
from about 15 to about 40 wt % of the used filler material;
wherein all weight percentages are based on a total weight of the first mixture.

13. The method of claim 1, further comprising:
incorporating the free-flowing powder into a new carpet component.

14. The method of claim 13, wherein the new carpet component comprises a new carpet backing, a new carpet adhesive component, or a combination thereof.

15. A method of recycling carpet components, said method comprising:
pre-heating at least one recycled carpet component to a temperature so as to remove organic material from the at least one recycled carpet component without negatively impacting any used filler material therein;
separating at least a portion of any fibers present within the at least one recycled carpet component so as to form a second mixture comprising residual carpet fibers, a residual carpet adhesive component, and used filler material; and
co-grinding the second mixture with a solid inorganic particulate material, wherein said co-grinding step results in a third mixture comprising a free-flowing powder having an average particle size.

16. The method of claim 15, wherein the solid inorganic particulate material comprises solid inorganic particulate material that is at least partially encapsulated within or coated with a polymeric or resinous material.

17. A free-flowing powder comprising:
particles of recycled carpet material, said recycled carpet material comprising residual carpet fibers or carpet fiber portions, a carpet adhesive component, and used filler material; and
solid inorganic particulate material that is at least partially encapsulated within or coated with a polymeric or resinous material, said solid inorganic particulate material being from a source other than recycled carpet material;
wherein said free-flowing powder has an average particle size ranging from about 1.0 to about 50 microns (μm).

18. The free-flowing powder of claim 17, wherein said free-flowing powder has a particle size ranging from about 10 to about 300 microns (μm).

19. The free-flowing powder of claim 17, wherein at least a portion of the free-flowing powder comprises particles comprising (i) a portion of the carpet adhesive component at least partially surrounded by (ii) a portion of the solid inorganic particulate material that is at least partially encapsulated within or coated with a polymeric or resinous material.

20. A new carpet component comprising the free-flowing powder of claim 17.
